(19) United States
(12) Patent Application Publication
(10) Pub. No.: US 2017/0062131 A1
(43) Pub. Date: Mar. 2, 2017

(54) Method of Manufacturing Heat Transmission Structure of Capacitor

(71) Applicant: AID ELECTRONICS CORPORATION, Taichung City (TW)

(72) Inventors: Hung-Min Yeh, Taichung City (TW); Sheng-Ghiee Chin, Taichung City (TW)

(21) Appl. No.: 14/833,196

(22) Filed: Aug. 24, 2015

(51) Int. Cl. H01G 4/005; B23K 31/02

(52) U.S. Cl. CPC H01G 4/005; B23K 31/02

(57) ABSTRACT

A method of manufacturing a heat transmission structure of a capacitor comprising steps of: A. rolling a metal film around a hollow shaft and fixing the hollow shaft into a capacitor; B. forming inner threads in the hollow shaft; C. forming a first electrode surface on a first end of the capacitor and a second electrode surface on a second end of the capacitor, and inserting a first electrode connector into the first end of the capacitor and a second electrode connector into the second end of the capacitor; D. screwing the first outer threads with the inner threads of the hollow shaft; E. fixing an insulator into the hollow shaft; F. screwing the second outer threads with the inner threads of the hollow shaft; G. welding the first welding face on the first electrode surface, and welding the second welding face on the second electrode surface.

### FIELD OF THE INVENTION

The present invention relates to a method of manufacturing a heat transmission structure of a capacitor which dissipates heat of the capacitor quickly.

### BACKGROUND OF THE INVENTION

With reference to FIG. 1, a conventional capacitor 10 contains a hollow shaft 20 inserted into the capacitor 10 and made of plastic material, wherein the capacitor 10 includes a first electrode surface 11 formed on a first end thereof and includes a second electrode surface 12 formed on a second end thereof. A first electrode connector 13 is welded with the first electrode surface 11, and a second electrode connector 14 is welded with the second electrode surface 12, i.e., the first electrode connector 13 has a first welding face 15 welded with the first electrode surface 11, and the second electrode connector 14 has a second welding face 16 welded with the second electrode surface 15.

However, heat of the conventional capacitor 10 transmits slowly toward the first electrode surface 11 and the second electrode surface 12 to increase a temperature of the conventional capacitor 10 over 180° C., so the capacitor 10 is broken easily. The present invention has arisen to mitigate and/or obviate the afore-described disadvantages.

### SUMMARY OF THE INVENTION

The primary objective of the present invention is to provide a method of manufacturing a heat transmission structure of a capacitor which dissipates heat of the capacitor quickly.

To obtain above-mentioned objective, a method of manufacturing a heat transmission structure of a capacitor provided by the present invention contains steps of:

A. rolling a metal film around a hollow shaft and fixing the hollow shaft into a through hole of a capacitor;

B. forming inner threads on an inner wall of the hollow shaft;

C. forming a first electrode surface on a first end of the capacitor and a second electrode surface on a second end of the capacitor, and inserting a first electrode connector into the first end of the capacitor and a second electrode connector into the second end of the capacitor, wherein the first electrode connector includes a first welding face and first outer threads formed on an outer wall of a circular extension of the first electrode connector, and the second electrode connector includes a second welding face and second outer threads formed on an outer wall of a circular extension of the second electrode connector;

D. screwing the first outer threads of the first electrode connector with the inner threads of the hollow shaft from the first end of the capacitor;

E. fixing an insulator into a central section of the inner wall of the hollow shaft;

F. screwing the second outer threads of the second electrode connector with the inner threads of the hollow shaft from the second end of the capacitor; and

G. welding the first welding face of the first electrode connector on the first electrode surface of the capacitor, and welding the second welding face of the second electrode connector on the second electrode surface of the capacitor.

### BRIEF DESCRIPTION OF THE DRAWINGS

FIG. 1 is a cross sectional view showing the operation of a conventional capacitor.

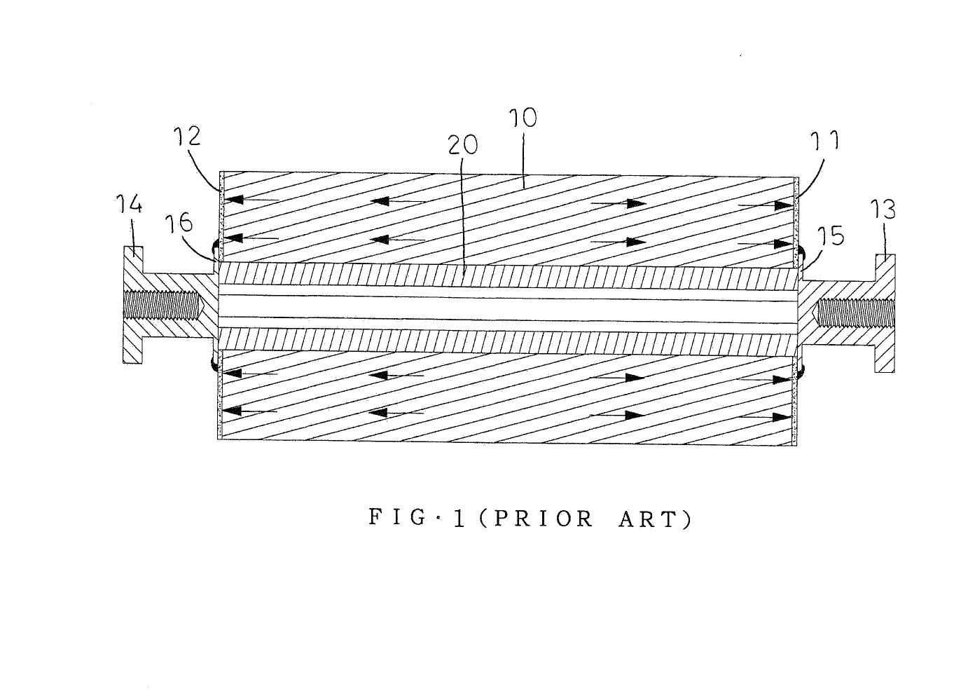

FIG. 2 is a perspective view showing the assembly of a capacitor according to a preferred embodiment of the present invention.

FIG. 3 is a perspective view showing the exploded components of the capacitor according to the preferred embodiment of the present invention.

FIG. 4 is a perspective view showing the operation of the capacitor according to the preferred embodiment of the present invention.

### DETAILED DESCRIPTION OF THE PREFERRED EMBODIMENTS

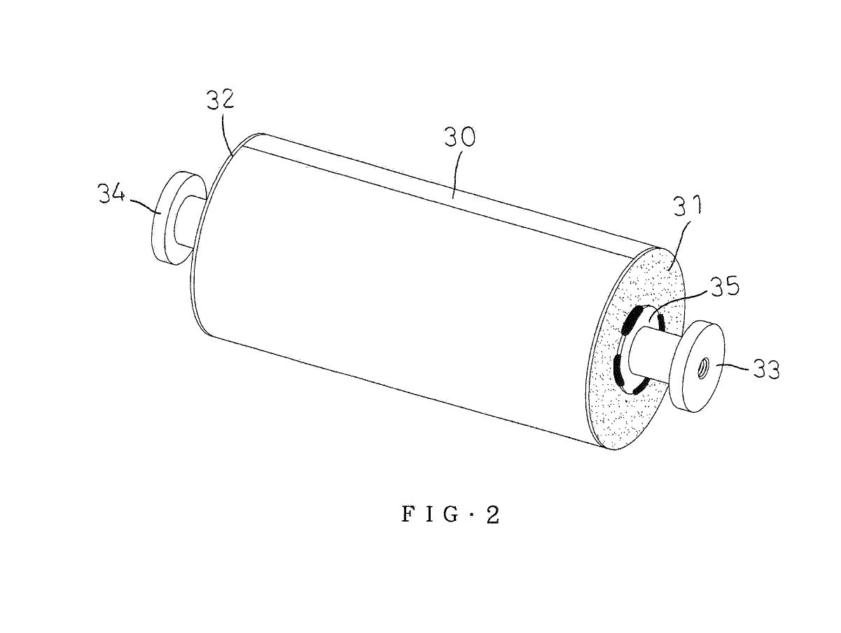

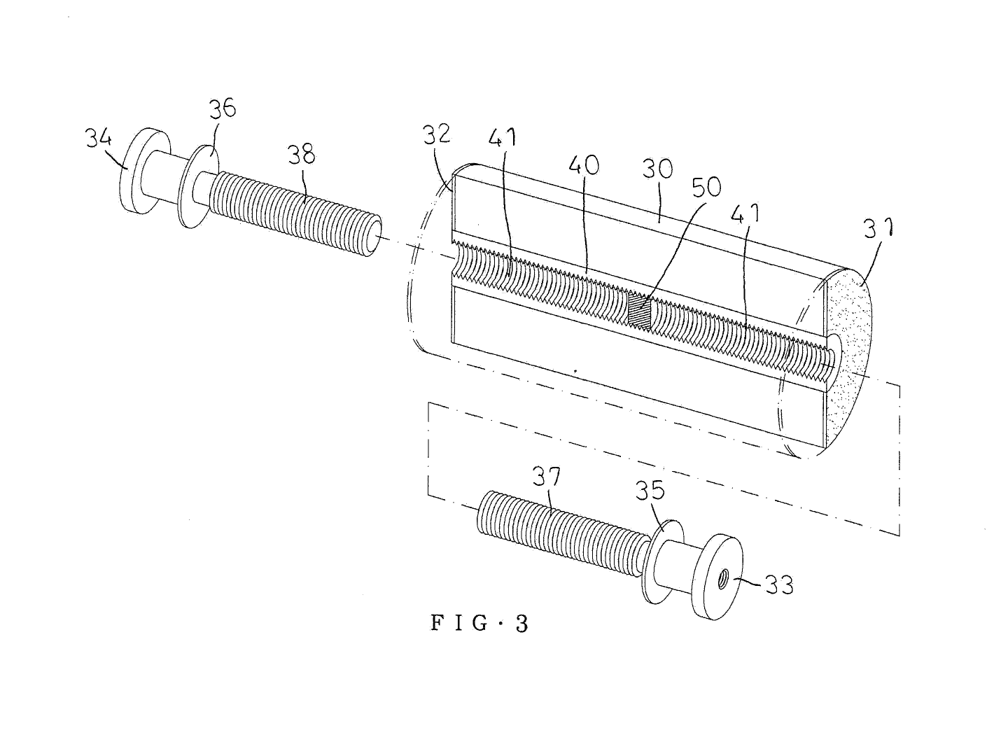

Referring to FIGS. 2 and 3, a method of manufacturing a heat transmission structure of a capacitor according to a preferred embodiment of the present invention comprises steps of:

A. rolling a metal film around a hollow shaft 40 and fixing the hollow shaft 40 into a through hole of a capacitor 30, wherein the hollow shaft 40 is made of plastic material, such as polyamide 6 (PA6);

B. forming inner threads 41 on an inner wall of the hollow shaft 40;

C. forming a first electrode surface 31 on a first end of the capacitor 30 and a second electrode surface 32 on a second end of the capacitor 30, and inserting a first electrode connector 33 into the first end of the capacitor 30 and a second electrode connector 34 into the second end of the capacitor 30, wherein each of the first electrode connector 33 and the second electrode connector 34 is made of copper or aluminum, the first electrode connector 33 includes a first welding face 35 and first outer threads 37 formed on an outer wall of a circular extension of the first electrode connector 33, and the second electrode connector 34 includes a second welding face 36 and second outer threads 38 formed on an outer wall of a circular extension of the second electrode connector 34;

D. screwing the first outer threads 37 of the first electrode connector 33 with the inner threads 41 of the hollow shaft 40 from the first end of the capacitor 30;

E. fixing an insulator 50 into a central section of the inner wall of the hollow shaft 40, wherein the insulator 50 is made of resin;

F. screwing the second outer threads 38 of the second electrode connector 34 with the inner threads 41 of the hollow shaft 40 from the second end of the capacitor 30;

G. welding the first welding face 35 of the first electrode connector 33 on the first electrode surface 31 of the capacitor 30, and welding the second welding face 36 of the second electrode connector 34 on the second electrode surface 32 of the capacitor 30.

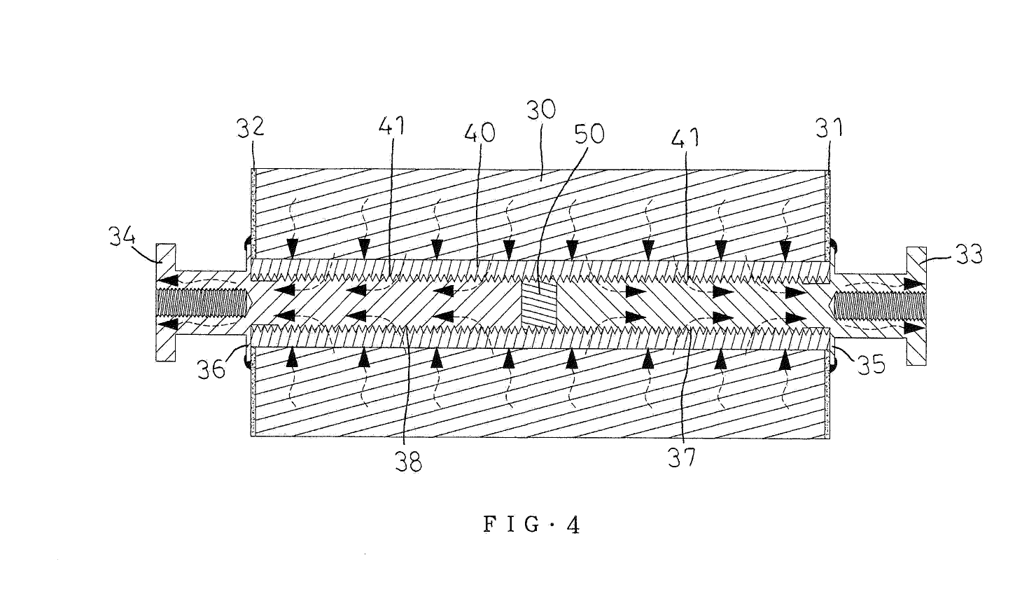

As shown in FIG. 4, in operation, heat of the capacitor 30 transmits toward the first outer threads 37 and the second outer threads 38 via the hollow shaft 40, and the heat transmits out of the first electrode connector 33 and the second electrode connector 34 from the first outer threads 37 and the second outer threads 38 to reduce a temperature of the capacitor 30 from 180° C. to 150° C., thus dissipating the heat of the capacitor 30 quickly.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A method of manufacturing a heat transmission structure of a capacitor comprising steps of:
A. rolling a metal film around a hollow shaft and fixing the hollow shaft into a through hole of a capacitor;
B. forming inner threads on an inner wall of the hollow shaft;
C. forming a first electrode surface on a first end of the capacitor and a second electrode surface on a second end of the capacitor, and inserting a first electrode connector into the first end of the capacitor and a second electrode connector into the second end of the capacitor, wherein the first electrode connector includes a first welding face and first outer threads formed on an outer wall of a circular extension of the first electrode connector, and the second electrode connector includes a second welding face and second outer threads formed on an outer wall of a circular extension of the second electrode connector;
D. screwing the first outer threads of the first electrode connector with the inner threads of the hollow shaft from the first end of the capacitor;
E. fixing an insulator into a central section of the inner wall of the hollow shaft;
F. screwing the second outer threads of the second electrode connector with the inner threads of the hollow shaft from the second end of the capacitor; and
G. welding the first welding face of the first electrode connector on the first electrode surface of the capacitor, and welding the second welding face of the second electrode connector on the second electrode surface of the capacitor.

2. The method of manufacturing the heat transmission structure of the capacitor as claimed in claim 1, wherein the hollow shaft is made of polyamide 6 (PA6).

3. The method of manufacturing the heat transmission structure of the capacitor as claimed in claim 1, wherein the insulator is made of resin.

4. The method of manufacturing the heat transmission structure of the capacitor as claimed in claim 1, wherein each of the first electrode connector and the second electrode connector is made of copper.

5. The method of manufacturing the heat transmission structure of the capacitor as claimed in claim 1, wherein each of the first electrode connector and the second electrode connector is made of aluminum.
